(19) United States
(12) Patent Application Publication
(10) Pub. No.: US 2026/0133096 A1
(43) Pub. Date: May 14, 2026

(54) SUNROOF TEST APPARATUS OF VEHICLE AND METHOD THEREOF

(71) Applicants: Hyundai Motor Company, Seoul (KR); Kia Corporation, Seoul (KR)

(72) Inventors: Eon Ryeol Jeon, Hwaseong-Si (KR); Hae Yoon Jung, Hwaseong-Si (KR); Seul Gi Kim, Hwaseong-Si (KR); Kyeong Chan Lee, Hwaseong-Si (KR); Sang Sub Um, Hwaseong-Si (KR); Jae Dong Shin, Hwaseong-Si (KR)

(21) Appl. No.: 19/177,916

(22) Filed: Apr. 14, 2025

(30) Foreign Application Priority Data
Nov. 14, 2024 (KR) 10-2024-0162363

(51) Int. Cl. G01M 17/00

(52) U.S. Cl. CPC G01M 17/00

(57) ABSTRACT

A sunroof test apparatus of a vehicle and a method thereof are provided. The sunroof test apparatus obtains specification information of a roof control module (RCM) over an in-vehicle network, determines a test case set corresponding to the specification information, transmits an operation command corresponding to each test case included in the test case set to the RCM, and analyzes response information from the RCM to determine a status of the sunroof, thus testing whether the sunroof provided in the vehicle normally operates irrespective of a type of the sunroof.

### CROSS-REFERENCE TO RELATED APPLICATION

This application claims priority to Korean Patent Application No. 10-2024-0162363, filed in the Korean Intellectual Property Office on Nov. 14, 2024, the entire contents of which are incorporated herein by reference.

### TECHNICAL FIELD

The present disclosure relates to automobile components, and more specifically to sunroofs.

### BACKGROUND

An opening for discharging air in a vehicle to the outside or introducing external air into the vehicle may be formed on a roof panel of the vehicle. Such an opening may be implemented with a sunroof glass that can be opened or closed.

Particularly, for a more expansive view and excellent design aesthetics, a panoramic sunroof, which covers most of the roof panel of the vehicle with glass and allows selective opening and closing of a part thereof, has gained prominence in many vehicles.

A driver may open the glass of the panoramic sunroof to, for example, enjoy a cool breeze while driving the vehicle or may receive more sunlight compared to a non-panoramic sunroof.

Such a panoramic sunroof may be composed of front glass mounted to be slidable on the front of the roof panel and rear glass fixedly mounted on the rear of the roof panel. The front glass may slide in a front and rear direction (e.g., the longitudinal direction of the vehicle) by a drive motor.

There are various types of sunroofs that are available for being mounted on a vehicle. For example, there are a normal sunroof composed of movable glass opened and closed by a motor and a manual sunshade, a vision roof composed of stationary glass and a movable blind opened and closed by a motor, a wide sunroof composed of movable glass opened by a first motor and a movable blind opened and closed by a second motor, a dual sunroof composed of front glass opened and closed by a first motor and a rear blind opened and closed by a second motor, and the like.

Various types of sunroofs may be mounted on vehicles. From the perspective of a quality control inspector, the inspector must inspect and identify specifications of the sunroof mounted on the vehicle in detail, select a test case corresponding to the identified sunroof, and analyze the test result one by one to determine whether the status of the sunroof is normal or abnormal.

Considering that the number of sunroofs to be tested may be in the hundreds or even in the thousands, the test process (e.g., inspection) of the inspector may require considerable human and material costs.

Details described in the background art are written to increase the understanding of the background of the present disclosure, which may include details rather than an existing technology well known to those skilled in the art.

### SUMMARY

The present disclosure has been made to solve the above-mentioned problems occurring in the prior art while advantages achieved by the prior art are maintained intact.

An aspect of the present disclosure provides a sunroof test apparatus of a vehicle for obtaining specification information of a roof control module (RCM) over an in-vehicle network, determining a test case set corresponding to the specification information, transmitting an operation command corresponding to each test case included in the test case set to the RCM, and analyzing response information from the RCM to determine a status of the sunroof to test whether the sunroof provided in the vehicle normally operates irrespective of a type of the sunroof and a method thereof.

Another aspect of the present disclosure provides a sunroof test apparatus of a vehicle for performing controller area network (CAN) communication with a roof control module (RCM) provided in a vehicle to obtain specification information of the RCM, determining a test case set corresponding to the specification information, transmitting an operation command corresponding to each test case included in the test case set to the RCM, and analyzing response information from the RCM to determine a status of a sunroof to test whether the sunroof provided in the vehicle normally operates irrespective of a type of the sunroof and a method thereof.

Another aspect of the present disclosure provides a sunroof test apparatus of a vehicle for obtaining specification information of a roof control module (RCM) over an in-vehicle network, determining a test case set corresponding to the specification information, transmitting an operation command corresponding to each test case included in the test case set to the RCM, receiving response information from the RCM, and determining a status of a sunroof based on a time taken from a time point when the operation command is transmitted and a time point when the response information is received to test whether the sunroof provided in the vehicle normally operates irrespective of a type of the sunroof and a method thereof.

Another aspect of the present disclosure provides a sunroof test apparatus of a vehicle for performing controller area network (CAN) communication with a roof control module (RCM) provided in a vehicle to obtain specification information of the RCM, determining a test case set corresponding to the specification information, transmitting an operation command corresponding to each test case included in the test case set to the RCM, receiving response information from the RCM, and determining a status of a sunroof based on a time taken from a time point when the operation command is transmitted and a time point when the response information is received to test whether the sunroof provided in the vehicle normally operates irrespective of a type of the sunroof and a method thereof.

The purposes of the present disclosure are not limited to the aforementioned purposes, and any other purposes and advantages not mentioned herein will be clearly understood from the following description and may more clearly be described in reference to one or more example embodiments of the present disclosure. Furthermore, it may be easily seen that purposes and advantages of the present disclosure may be implemented by means indicated in claims and a combination thereof.

An apparatus for testing a sunroof of a vehicle may comprise: a user interface configured to receive, from a user, a user input indicating a test initiation command; a communication circuit configured to provide an interface for accessing an in-vehicle network of the vehicle; a processor; and a memory storing at least one instruction that, when executed by the processor communicating with the memory, is configured to cause the apparatus to: obtain, via the in-vehicle network, specification information of a roof control module (RCM) of the vehicle; determine a test case set corresponding to the specification information; transmit, to the RCM, an operation command corresponding to each test case of the test case set; determine, based on response information received from the RCM, a status of the sunroof; and output, based on the determined status of the sunroof, a signal indicating the status of the sunroof.

The at least one instruction that, when executed by the processor communicating with the memory, may be configured to cause the apparatus to obtain the specification information by: determining, based on a controller area network (CAN) message periodically being transmitted from the RCM, whether the RCM is in normal operation.

The CAN message may comprise at least one of: current position information of the sunroof, initialization information of the sunroof, or failure information of the sunroof.

The at least one instruction that, when executed by the processor communicating with the memory, may be configured to cause the apparatus to determine the status of the sunroof by: determining, based on a test time duration from a first time when the operation command is transmitted to a second time when the response information is received, whether each test case passed, and wherein the response information corresponds to the operation command.

The at least one instruction that, when executed by the processor communicating with the memory, may be configured to cause the apparatus to determine the status of the sunroof by: determining, based on a test case of the test case set finishing after more than a reference time duration associated with the test case, that the test case failed.

The at least one instruction that, when executed by the processor communicating with the memory, may be configured to cause the apparatus to determine the status of the sunroof by: determining, based on a test case of the test case set finishing within a reference time duration associated with the test case and the apparatus not receiving any response information corresponding to a second operation command corresponding to the test case, that the test case failed.

The at least one instruction that, when executed by the processor communicating with the memory, may be configured to cause the apparatus to determine the status of the sunroof by: determining, based on a test case of the test case set finishing within a reference time duration associated with the test case and the apparatus receiving the response information, that the test case passed, and wherein the response information corresponds to the operation command.

The at least one instruction that, when executed by the processor communicating with the memory, may be configured to cause the apparatus to: move the sunroof to a test position before transmitting the operation command.

The at least one instruction that, when executed by the processor communicating with the memory, may be configured to cause the apparatus to determine the test case set by: excluding, based on a request from the user, at least one of a plurality of test cases of the test case set.

The sunroof may be a panoramic sunroof.

A method performed by an apparatus for testing a sunroof of a vehicle may comprise: obtaining, by the apparatus via an in-vehicle network of the vehicle, specification information of a roof control module (RCM) of the vehicle; determining, by the apparatus, a test case set corresponding to the specification information; transmitting, by the apparatus to the RCM, an operation command corresponding to each test case of the test case set; based on response information received from the RCM, determining, by the apparatus, a status of the sunroof; and outputting, based on the determined status of the sunroof, a signal indicating the status of the sunroof.

An apparatus for testing a sunroof of a vehicle may comprise: a communication circuit configured to communicate with a control circuit of the vehicle via an in-vehicle network of the vehicle, wherein the control circuit of the vehicle is configured to control the sunroof; a processor; and a memory storing at least one instruction that, when executed by the processor communicating with the memory, is configured to cause the apparatus to: receive, from the control circuit via the in-vehicle network, specification information associated with a type of the sunroof; determine a test case set corresponding to the specification information; transmit, to the control circuit, at least one operation command corresponding to a test case of the test case set; determine, based on a response time window for reception of a response from the control circuit, a status of the sunroof; and output, based on the determined status of the sunroof, a signal indicating the status of the sunroof, wherein the response time window is determined based on the specification information.

### BRIEF DESCRIPTION OF THE DRAWINGS

The above and other objects, features and advantages of the present disclosure will be more apparent from the following detailed description taken in conjunction with the accompanying drawings:

FIG. 1 is a diagram showing an example vehicle system to which a sunroof test apparatus of a vehicle is applied;

FIG. 2 is a diagram showing an example sunroof control system provided in a vehicle;

FIG. 3 is a diagram showing an example sunroof test apparatus of a vehicle;

FIG. 4 is a flowchart showing an example process of determining each test case as pass or fail in a controller provided in a sunroof test apparatus of a vehicle;

FIG. 5 is a flowchart showing an example process of determining each test case as pass or fail in a controller provided in a sunroof test apparatus of a vehicle;

FIG. 6 is a diagram showing an example process of determining each test case as pass in a controller provided in a sunroof test apparatus of a vehicle;

FIG. 7 is a table showing example results of applying each test case in a controller provided in a sunroof test apparatus of a vehicle;

FIG. 8 is a flowchart showing an example sunroof test method of a vehicle; and

FIG. 9 is a block diagram showing an example computing system for executing a sunroof test method of a vehicle.

### DETAILED DESCRIPTION

Hereinafter, exemplary embodiments of the present disclosure will be described in detail with reference to the accompanying drawings. In adding the reference numerals to the components of each drawing, it should be noted that the identical component is designated by the identical numerals even when they are displayed on other drawings. Further, in describing the embodiment of the present disclosure, a detailed description of well-known features or functions will be ruled out in order not to unnecessarily obscure the gist of the present disclosure.

In describing the components of the embodiment of the present disclosure, terms such as first, second, “A”, “B”, (a), (b), and the like may be used. These terms are only used to distinguish one component from another component, but do not limit the corresponding components irrespective of the order or priority of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations, functions, roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

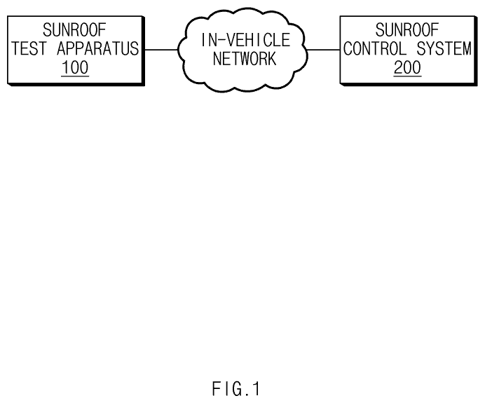

FIG. 1 is a diagram showing an example vehicle system to which a sunroof test apparatus of a vehicle is applied.

As shown in FIG. 1, the vehicle system may include a sunroof test apparatus 100 and a sunroof control system 200. The sunroof test apparatus 100 and the sunroof control system 200 may communicate with each other over an in-vehicle network. The in-vehicle network may include, for example, a controller area network (CAN), a controller area network with flexible data-rate (CAN FD), a local interconnect network (LIN), FlexRay, media oriented systems transport (MOST), Ethernet, or the like.

The sunroof test apparatus 100 may obtain specification information of the sunroof control system 200 over the in-vehicle network. The sunroof test apparatus 100 may determine a test case set corresponding to the specification information. The sunroof test apparatus 100 may transmit an operation command corresponding to each test case included in the test case set to the sunroof control system 200. The sunroof test apparatus 100 and may determine a status of a sunroof by, for example, analyzing response information received from the sunroof control system 200.

The sunroof test apparatus 100 may perform CAN communication with the sunroof control system 200 to obtain specification information of the sunroof control system 200. The sunroof test apparatus 100 may determine a test case set corresponding to the specification information. The sunroof test apparatus 100 may transmit an operation command corresponding to each test case included in the test case set to the sunroof control system 200. The sunroof test apparatus 100 may determine a status of the sunroof by, for example, analyzing response information received from the sunroof control system 200.

The sunroof test apparatus 100 may obtain specification information of the sunroof control system 200 over the in-vehicle network. The sunroof test apparatus 100 may determine a test case set corresponding to the specification information. The sunroof test apparatus 100 may transmit an operation command corresponding to each test case included in the test case set to the sunroof control system 200. The sunroof test apparatus 100 may receive response information from the sunroof control system 200. The sunroof test apparatus 100 may determine a status of a sunroof based on a time (e.g., time duration) taken from a time when the operation command is transmitted to a time when the response information is received.

The sunroof test apparatus 100 may perform CAN communication with the sunroof control system 200 provided in a vehicle to obtain specification information of the sunroof control system 200. The sunroof test apparatus 100 may determine a test case set corresponding to the specification information. The sunroof test apparatus 100 may transmit an operation command corresponding to each test case included in the test case set to the sunroof control system 200. The sunroof test apparatus 100 may receive response information from the sunroof control system 200. The sunroof test apparatus 100 may determine a status of a sunroof based on a time (e.g., time duration) taken from a time point when the operation command is transmitted to a time point when the response information is received.

The sunroof control system 200 may be a system provided in the vehicle to control an operation of the sunroof. The sunroof control system 200 may control an operation of the sunroof based on the operation command received from the sunroof test apparatus 100. The sunroof control system 200 may transmit response information according to the operation command (e.g., an operation result of the sunroof) to the sunroof test apparatus 100.

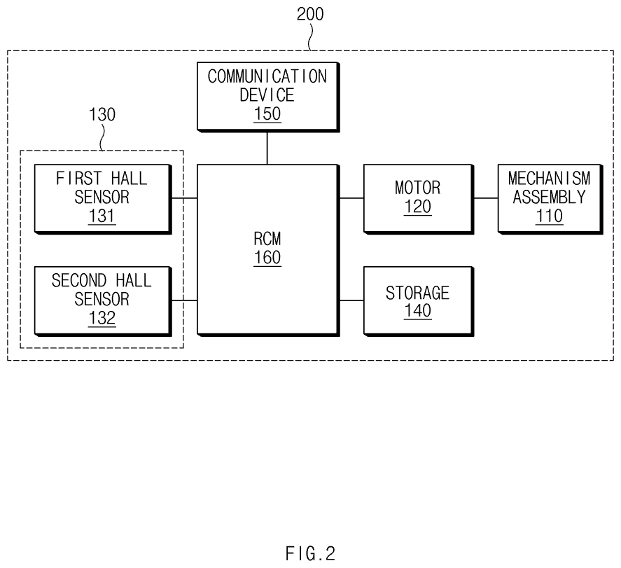

FIG. 2 is a diagram showing an example sunroof control system provided in a vehicle.

As shown in FIG. 2, a sunroof control system 200 provided in a vehicle may include a mechanism assembly 110, a motor 120, a position detection device 130, storage 140, a communication device 150, and a roof control module (RCM) 160.

The mechanism assembly 110 may be an instrument for substantially performing an opening and closing operation of a sunroof. The mechanism assembly 110 may slide or tilt a glass (e.g., a glass panel) or a blind of the sunroof to facilitate opening and closing of the sunroof.

The motor 120 may play a role in generating power for opening and closing the sunroof. The motor 120 may rotate in a clockwise or counterclockwise direction depending on an instruction of the RCM 160 to generate power. At this time, the motor 120 may be driven at a predetermined rotational velocity. The power generated by the rotation of the motor 120 may be delivered to the mechanism assembly 110.

A ring magnet may be installed on a rotary shaft of the motor 120 to be fixed. At this time, the ring magnet may be used to measure a rotational velocity of the motor 120.

The position detection device 130 may detect a glass position or a blind position of the sunroof. The position detection device 130 may include a first hall sensor 131 and a second hall sensor 132 (also referred to as first and second Hall-effect sensors). The position detection device 130 may measure a pinion angle of the motor 120 using the first hall sensor 131 and the second hall sensor 132 and may calculate a glass position or a blind position from the measured pinion angle.

The first hall sensor 131 and the second hall sensor 132 may measure a change in magnetic field of the ring magnet mounted on the motor 120. The first hall sensor 131 and the second hall sensor 132 may output four pulses (e.g., a 0V-12V square wave) when the motor 120 rotates once. The pulses output from the first hall sensor 131 and the second hall sensor 132 may be used to count the number of rotations of the motor 120. The first hall sensor 131 and the second hall sensor 132 may be used to measure a rotational velocity, an angular velocity, angular acceleration, and/or the like of the motor 120. Herein, as the principle of the hall sensor is the known art, a detailed description thereof will be omitted.

The storage 140 may store a program for an operation of the RCM 160 and may store a progress status and result according to the operation of the RCM 160. The memory 140 may be implemented as at least one of storage media, such as a flash memory, a hard disk, a random access memory (RAM), a static RAM (SRAM), a read only memory (ROM), a programmable ROM (PROM), an electrically erasable and programmable ROM (EEPROM), an erasable and programmable ROM (EPROM), and a register.

The storage 140 may store a lookup table in which an operation time of the sunroof is recorded. Herein, the operation time of the sunroof may refer to a time taken for the mechanism assembly 110 to switch the sunroof from an open state to a closed state or from the closed state to the open state. A time taken for each sunroof operation, that is, a time taken for an opening operation (Close→Open) or a time taken for a closing operation (Open→Close), which is obtained in advance via a sunroof operation test, may be defined in the lookup table.

The storage 140 may store a jamming recognition threshold profile. The jamming recognition threshold profile (also referred to as a “threshold profile”) may be a threshold of an anti-pinch force according to the position of the glass. Such a threshold of the anti-pinch force may be criteria for determining whether a jamming phenomenon occurs in the sunroof.

The communication device 150 may transmit and receive data with a sunroof test apparatus 100 over an in-vehicle network. The communication device 150 may receive an operation command from the sunroof test apparatus 100. The communication device 150 may transmit position information of the sunroof, state information of the motor 120, initialization information, and failure information, and the like to the sunroof test apparatus 100. Herein, the failure information may include failure information of the sunroof and failure information of the RCM 160.

The RCM 160 may control the overall operation of the sunroof control system 200. The RCM 160 may be implemented as at least one of an application specific integrated circuit (ASIC), a digital signal processor (DSP), programmable logic devices (PLD), field programmable gate arrays (FPGAs), a central processing unit (CPU), microcontrollers, or microprocessors.

Based on receiving a command, such as sunroof opening or sunroof closing, from the sunroof test apparatus 100, the RCM 160 may control a rotational direction of the motor 120 to control opening and closing of the sunroof. Based on receiving the opening command from the sunroof test apparatus 100, the RCM 160 may rotate the motor 120 in one direction (e.g., a clockwise direction) to open the sunroof. Based on receiving the closing command from the sunroof test apparatus 100, the RCM 160 may rotate the motor 120 in another direction (e.g., a counterclockwise direction) to close the sunroof. The RCM 160 may calculate an operation time of the sunroof.

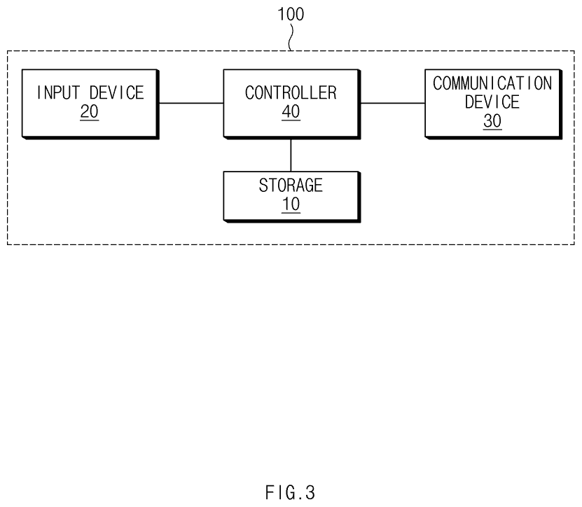

FIG. 3 is a diagram showing an example sunroof test apparatus of a vehicle.

As shown in FIG. 3, a sunroof test apparatus 100 of a vehicle according to an embodiment of the present disclosure may include storage 10, an input device 20, a communication device 30, and a controller 40. In this case, respective components may be coupled to each other to be implemented as one according to a scheme which executes the sunroof test apparatus 100 of the vehicle according to an embodiment of the present disclosure, and some components may be omitted.

The storage 10 may store various logic, algorithms, and programs required in a process of obtaining specification information of an RCM 160 over an in-vehicle network, determining a test case set corresponding to the specification information, transmitting an operation command corresponding to each test case included in the test case set to the RCM 160, and determining a status of a sunroof by, for example, analyzing response information received from the RCM 160.

The storage 10 may store various logic, algorithms, and programs required in a process of performing CAN communication with the RCM 160 provided in a vehicle to obtain specification information of the RCM 160, determining a test case set corresponding to the specification information, transmitting an operation command corresponding to each test case included in the test case set to the RCM 160, and analyzing response information from the RCM 160 to determine a status of a sunroof.

The storage 10 may store various logic, algorithms, and programs required in a process of obtaining specification information of the RCM 160 over an in-vehicle network, determining a test case set corresponding to the specification information, transmitting an operation command corresponding to each test case included in the test case set to the RCM 160, receiving response information from the RCM 160, and determining a status of a sunroof based on a time taken from a time point when the operation command is transmitted to a time point when the response information is received.

The storage 10 may store various logic, algorithms, and programs required in a process of performing CAN communication with the RCM 160 provided in the vehicle to obtain specification information of the RCM 160, determining a test case set corresponding to the specification information, transmitting an operation command corresponding to each test case included in the test case set to the RCM 160, receiving response information from the RCM 160, and determining a status of a sunroof based on a time (e.g., a time duration) taken from, for example, a first time when the operation command is transmitted to a second time when the response information is received.

The storage 10 may store a test case set corresponding to specifications of the RCM 160 (e.g., specifications of the sunroof). The storage 10 may store required time information for each test case in the test case set.

The input device 20 may receive a test initiation command, a test case set, various control command, or the like from a user. The input device 20 may provide the user with an interface for editing the test case set. For example, the user may not select (e.g., exclude) some of a plurality of test cases included in the test case set.

The communication device 30 may be a module for providing an interface for accessing an in-vehicle network, which may transmit and receive data with a sunroof control system 200. The communication device 30 may transmit an operation command to the sunroof control system 200 and may receive response information (e.g., open state information, closed state information, or the like) corresponding to the operation command from the sunroof control system 200. The communication device 30 may periodically receive position information of the sunroof, state information of a motor 120, initialization information, and failure information, and the like from the sunroof control system 200.

The controller 40 may be electrically connected with the respective components and may perform the overall control such that the respective components may normally perform their own functions. Such a controller 40 may be implemented in the form of hardware, may be implemented in the form of software, or may be implemented in the form of a combination thereof. Preferably, the controller 40 may be implemented as, but not limited to, a microprocessor.

The controller 40 may obtain specification information of the RCM 160 over the in-vehicle network, may determine a test case set corresponding to the specification information, may transmit an operation command corresponding to each test case included in the test case set to the RCM 160, and may analyze response information from the RCM 160 to determine a status of the sunroof.

The controller 40 may transmit an operation command corresponding to each test case to the RCM 160, may receive response information from the RCM 160, and may determine a status of the sunroof based on a time taken from a time point when the operation command is transmitted to a time point when the response information is received.

The controller 40 may check (e.g., determine) whether the RCM 160 normally operates (e.g., in normal operation or operating within predetermined parameters) based on a CAN message periodically transmitted from the RCM 160. At this time, the CAN message may include position information of the sunroof, state information of a motor 120, initialization information, failure information, and the like.

The controller 40 may exclude some of a plurality of test cases included in the test case set depending on a request from the user.

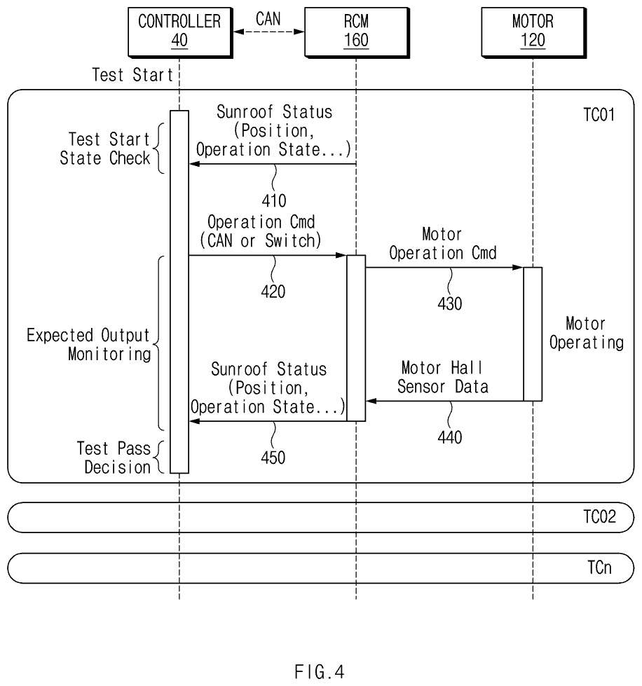

Hereinafter, the operation of the controller 40 will be described in detail with reference to FIGS. 4 to 7.

FIG. 4 is a flowchart showing an example process of determining each test case as pass or fail in a controller provided in a sunroof test apparatus of a vehicle.

In operation 410, a controller 40 may check whether an RCM 160 normally operates based on a CAN message periodically transmitted from the RCM 160.

When the RCM 160 normally operates, in operation 420, the controller 40 may transmit an operation command corresponding to No. 1 test case. At this time, the operation command may be any one of a command to open a sunroof glass, a command to close the sunroof glass, a command to open a sunroof blind, or a command to close the sunroof blind.

In operation 430, the RCM 160 may control driving of a motor 120 based on the operation command from the controller 40.

Thereafter, the RCM 160 may obtain data (e.g., the number of pulses) from hall sensors 131 and 132 provided in the motor 120.

The RCM 160 may determine a position of the sunroof (e.g., a position of the sunroof glass and/or a position of the sunroof blind) based on the data from the hall sensors 131 and 132 and may transmit the position of the sunroof as response information to the controller 40.

The controller 40 may determine whether a first test case is passed (e.g., a pass) based on whether response information corresponding to the operation command is received within a reference time corresponding to the operation command.

For example, based on the response information corresponding to the operation command being received within the reference time corresponding to the operation command, the controller 40 may determine whether a sunroof control system 200 passes the first test case.

For another example, when the response information corresponding to the operation command is not received within the reference time corresponding to the operation command, the response information corresponding to the operation command is received out of the reference time corresponding to the operation command, or there is no response within the reference time corresponding to the operation command, the controller 40 may determine that the sunroof control system 200 fails in passing the first test case.

The controller 40 may apply, for example, a second test case, a third test case, and so forth all the way through the final test case to the sunroof control system in such a manner.

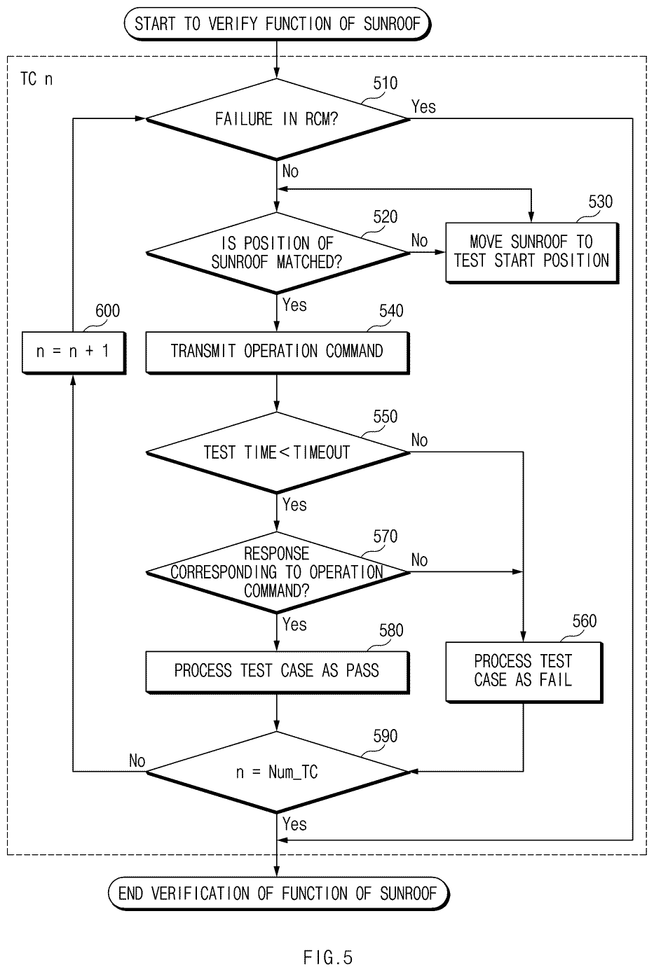

FIG. 5 is a flowchart showing an example process of determining each test case as pass or fail in a controller provided in a sunroof test apparatus of a vehicle.

When it starts to verify a function of a sunroof, in operation 510, a controller 40 may check whether an RCM 160 fails based on a CAN message periodically received from the RCM 160. At this time, when failure occurs in the RCM 160, the process of verifying the function of the sunroof may be terminated.

When the RCM 160 normally operates (e.g., operates within predetermined parameters), the controller 40 may check an operation command corresponding to a test case. If a sunroof is not located at a position corresponding to the operation command in operation 520, in operation 530, the controller 40 may transmit a command to move the sunroof to a test start position to the RCM 160.

If the RCM 160 normally operates (e.g., operates within predetermined parameters), the controller 40 may check the operation command corresponding to the test case. If the sunroof is located at the position corresponding to the operation command in operation 520, in operation 540, the controller 40 may transmit the operation command to the RCM 160.

In operation 550, the controller 40 may check whether a test time is less than timeout (e.g., a reference time).

When the test time is greater than or equal to the timeout, that is, when a time from a time point when the operation command is transmitted to a time point when a response is received (e.g., the test time) is greater than or equal to the timeout, in operation 560, the controller 40 may process the test case as fail.

When the test time is less than the timeout, but the received response is not a response corresponding to the operation command in operation 570, in operation 560, the controller 40 may process the test case as failure.

When the test time is less than the timeout and the received response is the response corresponding to the operation command in operation 570, in operation 580, the controller 40 may process the test case as pass.

Thereafter, in operations 590 and 600, the controller 40 may repeatedly perform operations 510 to 580 for the remaining test cases.

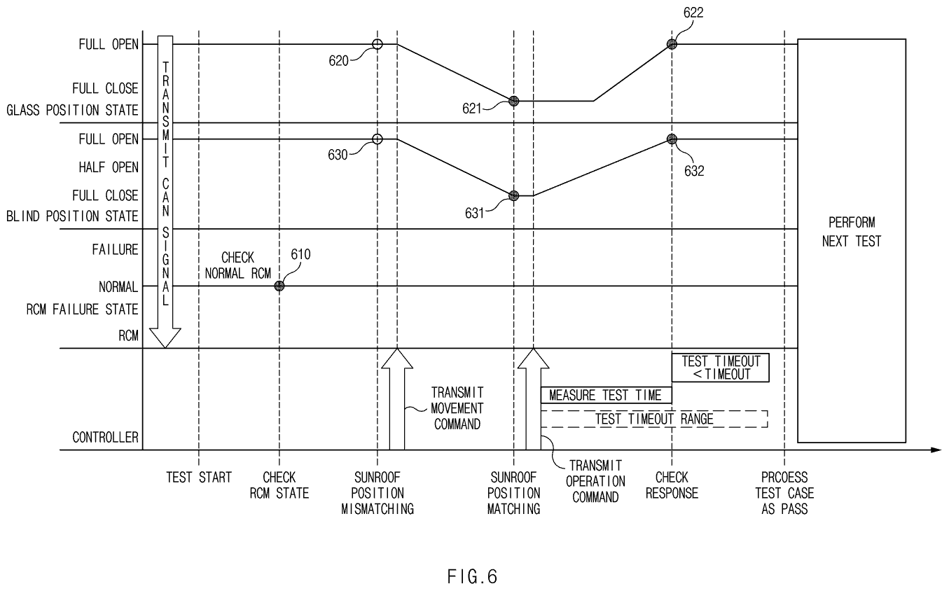

FIG. 6 is a diagram showing an example process of determining each test case as pass in a controller provided in a sunroof test apparatus of a vehicle.

After a test starts, in operation 610, a controller 40 may check that an RCM 160 normally operates based on a CAN message periodically transmitted from the RCM 160.

If a command corresponding to a test case is full open of a sunroof, as the current position of the sunroof is a full open state (e.g., a glass full open state 620 and a blind full open state 630), the controller 40 may transmit a movement command to the RCM 160 to change the position of the sunroof to a full closed state. If the current position of the sunroof is the full closed state, there may be no need to perform such a process.

The position of the sunroof changes to the full closed state (e.g., a glass full closed state 621 and a blind full closed state 631) by the movement command. As a result, preparation capable of applying the test case is completed.

The controller 40 may transmit a command to fully open the sunroof as the operation command corresponding to the test case to the RCM 160, may check a full open state (e.g., a glass full open state 622 and a blind full open state 632) of the sunroof within test timeout (e.g., a reference time), and may process the test case as pass. Herein, when receiving the operation command from the controller 40, the RCM 160 may first operate a blind and may then operate a glass. However, a full open time point of the glass and a full open time point of the blind may be the same as each other.

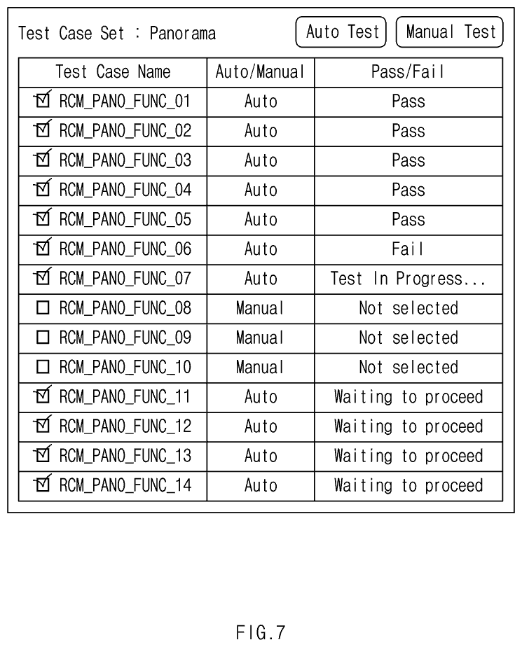

FIG. 7 is a table showing example results of applying each test case in a controller provided in a sunroof test apparatus of a vehicle.

As shown in FIG. 7, a test case set may include various test cases, such as “RCM_PANO_FUNC_01” through “RCM_PANO_FUNC_14”. In this example, test results for “RCM_PANO_FUNC_01” through “RCM_PANO_FUNC_05” are indicated as pass (e.g., successful). The result for a test case “RCM_PANO_FUNC_06” is indicated as fail (e.g., unsuccessful). A test case “RCM_PANO_FUNC_07” is being currently tested. Test cases from “RCM_PANO_FUNC_08” to “RCM_PANO_FUNC_10” are not selected by a user. Test cases from “RCM_PANO_FUNC_11” to “RCM_PANO_FUNC_14” is currently waiting for testing.

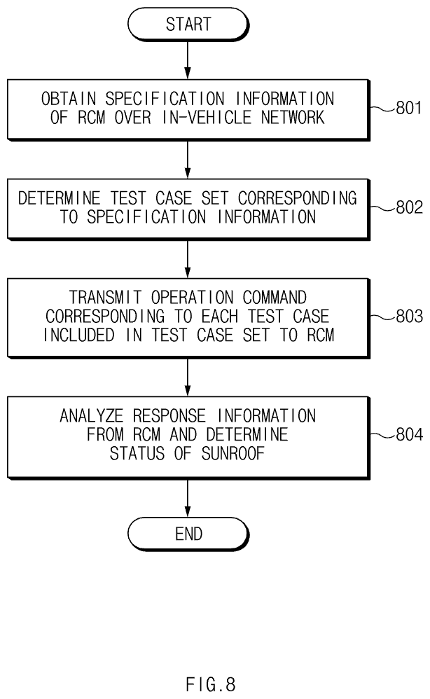

FIG. 8 is a flowchart showing an example sunroof test method of a vehicle.

If a test initiation command is received from a user via an input device 20, in operation 801, a controller 40 may obtain specification information of a roof control module (RCM) over an in-vehicle network.

In operation 802, the controller 40 may determine

A test case set corresponding to the specification information.

In operation 803, the controller 40 may transmit an operation command corresponding to each test case included in the test case set to the RCM.

In operation 804, the controller 40 may analyze response information from the RCM and may determine a status of a sunroof.

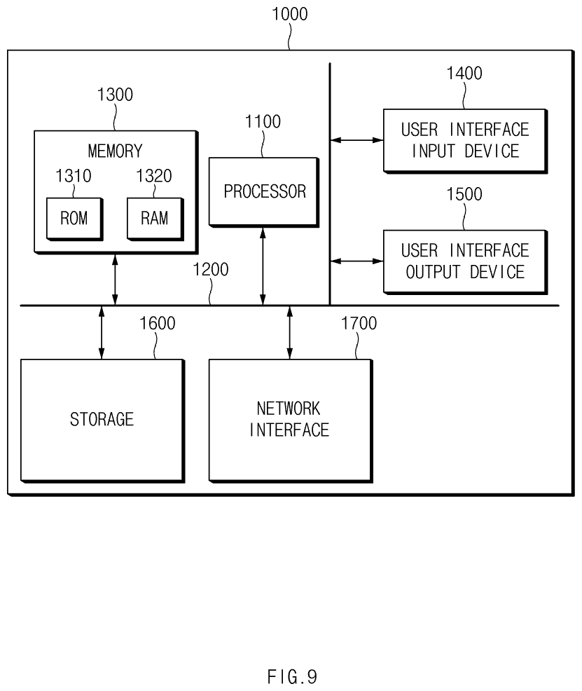

FIG. 9 is a block diagram showing an example computing system for executing a sunroof test method of a vehicle.

Referring to FIG. 9, the above-mentioned sunroof test method of the vehicle according to an embodiment of the present disclosure may be implemented via a computing system 1000. The computing system 1000 may include at least one processor 1100, a memory 1300, a user interface input device 1400, a user interface output device 1500, storage 1600, and a network interface 1700, which are connected with each other through a system bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (e.g., the memory 1300 and/or the storage 1600) such as a RAM, a flash memory, a ROM, an EPROM, an EEPROM, a register, a hard disc, a removable disk, and a CD-ROM. The exemplary storage medium may be coupled to the processor 1100. The processor 1100 may read out information from the storage medium and may write information in the storage medium. Alternatively, the storage medium may be integrated with the processor 1100. The processor 110 and the storage medium may reside in an application specific integrated circuit (ASIC). The ASIC may reside within a user terminal. In another case, the processor 1100 and the storage medium may reside in the user terminal as separate components.

According to one or more example embodiments of the present disclosure, specification information of a roof control module (RCM) may be obtained over an in-vehicle network, a test case set corresponding to the specification information may be determined, an operation command corresponding to each test case included in the test case set may be transmitted to the RCM, and a status of the sunroof may be determined by, for example, analyzing response information received from the RCM. Thus whether the sunroof provided in the vehicle normally operates may be tested irrespective of a type of the sunroof.

According to an aspect of the present disclosure, a sunroof test apparatus of a vehicle may include an input device that receives a test initiation command from a user, a communication device that provides an interface for accessing an in-vehicle network, and a controller electrically connected with the input device and the communication device. The controller may obtain specification information of a roof control module (RCM) over the in-vehicle network, may determine a test case set corresponding to the specification information, may transmit an operation command corresponding to each test case included in the test case set to the RCM, and may analyze response information from the RCM to determine a status of the sunroof.

The controller may check whether the RCM normally operates based on a controller area network (CAN) message periodically transmitted from the RCM.

The CAN message may include at least one of current position information, initialization information, or failure information of the sunroof.

The controller may determine whether each test case is passed, based on a time taken from a time point when the operation command is transmitted to a time point when the response information corresponding to the operation command is received.

The controller may process a first test case as fail, when a time taken in the first test case is greater than or equal to a reference time corresponding to the first test case.

The controller may process a first test case as fail, when a time taken in the first test case is less than a reference time corresponding to the first test case, but not receiving the response information corresponding to the operation command.

The controller may process a first test case as pass, when a time taken in the first test case is less than a reference time corresponding to the first test case and receiving the response information corresponding to the operation command.

The controller may move a current position of the sunroof to a test position before transmitting the operation command, when the current position of the sunroof is not the test position.

The controller may exclude some of a plurality of test cases included in the test case set depending on a request from the user.

The sunroof may be a panorama sunroof.

According to another aspect of the present disclosure, a sunroof test method of a vehicle may include obtaining, by a controller, specification information of a roof control module (RCM) over an in-vehicle network, determining, by the controller, a test case set corresponding to the specification information, transmitting, by the controller, an operation command corresponding to each test case included in the test case set to the RCM, and analyzing, by the controller, response information from the RCM to determine a status of a sunroof.

The obtaining of the specification information of the RCM may include checking whether the RCM normally operates based on a controller area network (CAN) message periodically transmitted from the RCM.

The CAN message may include at least one of current position information, initialization information, or failure information of the sunroof.

The determining of the status of the sunroof may include determining whether each test case is passed, based on a time taken from a time point when the operation command is transmitted to a time point when the response information corresponding to the operation command is received.

The determining of whether each test case is passed may include processing a first test case as fail, when a time taken in the first test case is greater than or equal to a reference time corresponding to the first test case.

The determining of whether each test case is passed may include processing a first test case as fail, when a time taken in the first test case is less than a reference time corresponding to the first test case, but not receiving the response information corresponding to the operation command.

The determining of whether each test case is passed may include processing a first test case as pass, when a time taken in the first test case is less than a reference time corresponding to the first test case and receiving the response information corresponding to the operation command.

The transmitting of the operation command to the RCM may include transmitting a command to move a current position of the sunroof to a test position, when the current position of the sunroof is not the test position.

The determining of the test case set may include excluding some of a plurality of test cases included in the test case set depending on a request from a user.

Although the present disclosure has been described with reference to one or more example embodiments and the accompanying drawings, the present disclosure is not limited thereto, and may be variously modified and altered by those skilled in the art to which the present disclosure pertains without departing from the spirit and scope of the present disclosure claimed in the following claims. Therefore, example embodiments of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. An apparatus for testing a sunroof of a vehicle, the apparatus comprising:
a user interface configured to receive, from a user, a user input indicating a test initiation command;
a communication circuit configured to provide an interface for accessing an in-vehicle network of the vehicle;
a processor; and
a memory storing at least one instruction that, when executed by the processor communicating with the memory, is configured to cause the apparatus to:
obtain, via the in-vehicle network, specification information of a roof control module (RCM) of the vehicle;
determine a test case set corresponding to the specification information;
transmit, to the RCM, an operation command corresponding to each test case of the test case set;
determine, based on response information received from the RCM, a status of the sunroof; and
output, based on the determined status of the sunroof, a signal indicating the status of the sunroof.

2. The apparatus of claim 1, wherein the at least one instruction that, when executed by the processor communicating with the memory, is configured to cause the apparatus to obtain the specification information by:
determining, based on a controller area network (CAN) message periodically being transmitted from the RCM, whether the RCM is in normal operation.

3. The apparatus of claim 2, wherein the CAN message comprises at least one of: current position information of the sunroof, initialization information of the sunroof, or failure information of the sunroof.

4. The apparatus of claim 1, wherein the at least one instruction that, when executed by the processor communicating with the memory, is configured to cause the apparatus to determine the status of the sunroof by:
determining, based on a test time duration from a first time when the operation command is transmitted to a second time when the response information is received, whether each test case passed, and wherein the response information corresponds to the operation command.

5. The apparatus of claim 1, wherein the at least one instruction that, when executed by the processor communicating with the memory, is configured to cause the apparatus to determine the status of the sunroof by:
determining, based on a test case of the test case set finishing after more than a reference time duration associated with the test case, that the test case failed.

6. The apparatus of claim 1, wherein the at least one instruction that, when executed by the processor communicating with the memory, is configured to cause the apparatus to determine the status of the sunroof by:
determining, based on a test case of the test case set finishing within a reference time duration associated with the test case and the apparatus not receiving any response information corresponding to a second operation command corresponding to the test case, that the test case failed.

7. The apparatus of claim 1, wherein the at least one instruction that, when executed by the processor communicating with the memory, is configured to cause the apparatus to determine the status of the sunroof by:
determining, based on a test case of the test case set finishing within a reference time duration associated with the test case and the apparatus receiving the response information, that the test case passed, and wherein the response information corresponds to the operation command.

8. The apparatus of claim 1, wherein the at least one instruction that, when executed by the processor communicating with the memory, is configured to cause the apparatus to:
move the sunroof to a test position before transmitting the operation command.

9. The apparatus of claim 1, wherein the at least one instruction that, when executed by the processor communicating with the memory, is configured to cause the apparatus to determine the test case set by:
excluding, based on a request from the user, at least one of a plurality of test cases of the test case set.

10. The apparatus of claim 1, wherein the sunroof is a panoramic sunroof.

11. A method performed by an apparatus for testing a sunroof of a vehicle, the method comprising:
obtaining, by the apparatus via an in-vehicle network of the vehicle, specification information of a roof control module (RCM) of the vehicle;
determining, by the apparatus, a test case set corresponding to the specification information;
transmitting, by the apparatus to the RCM, an operation command corresponding to each test case of the test case set;
based on response information received from the RCM, determining, by the apparatus, a status of the sunroof; and
outputting, based on the determined status of the sunroof, a signal indicating the status of the sunroof.

12. The method of claim 11, wherein the obtaining of the specification information comprises:
determining, based on a controller area network (CAN) message periodically being transmitted from the RCM, whether the RCM is in normal operation.

13. The method of claim 12, wherein the CAN message comprises at least one of: current position information of the sunroof, initialization information of the sunroof, or failure information of the sunroof.

14. The method of claim 11, wherein the determining of the status of the sunroof comprises:
determining, based on a test time duration from a first time when the operation command is transmitted to a second time when the response information is received, whether each test case passed, and wherein the response information corresponds to the operation command.

15. The method of claim 11, wherein the determining of the status of the sunroof comprises:
determining, based on a test case of the test case set finishing after more than a reference time duration associated with the test case, that the test case failed.

16. The method of claim 11, wherein the determining of the status of the sunroof comprises:
determining, based on a test case of the test case set finishing within a reference time duration associated with the test case and the apparatus not receiving any response information corresponding to a second operation command corresponding to the test case, that the test case failed.

17. The method of claim 11, wherein the determining of the status of the sunroof comprises:
determining, based on a test case of the test case set finishing within a reference time duration associated with the test case and the apparatus receiving the response information, that the test case passed, and wherein the response information corresponds to the operation command.

18. The method of claim 11, further comprising:
before transmitting the operation command, transmitting a command to move the sunroof to a test position.

19. The method of claim 11, wherein the determining of the test case set comprises:
excluding, based on a request from the user, at least one of a plurality of test cases of the test case set.

20. An apparatus for testing a sunroof of a vehicle, the apparatus comprising:
a communication circuit configured to communicate with a control circuit of the vehicle via an in-vehicle network of the vehicle, wherein the control circuit of the vehicle is configured to control the sunroof;
a processor; and
a memory storing at least one instruction that, when executed by the processor communicating with the memory, is configured to cause the apparatus to:
receive, from the control circuit via the in-vehicle network, specification information associated with a type of the sunroof;
determine a test case set corresponding to the specification information;
transmit, to the control circuit, at least one operation command corresponding to a test case of the test case set;
determine, based on a response time window for reception of a response from the control circuit, a status of the sunroof; and
output, based on the determined status of the sunroof, a signal indicating the status of the sunroof,
wherein the response time window is determined based on the specification information.
